(19) United States
(12) Patent Application Publication
(10) Pub. No.: US 2024/0345388 A1
(43) Pub. Date: Oct. 17, 2024

(54) OUTPUT COUPLER FOR DEPTH OF FIELD CONFIGURATION IN AN EYE TRACKING SYSTEM

(71) Applicant: Meta Platforms Technologies, LLC, Menlo Park, CA (US)

(72) Inventors: Yang Yang, Redmond, WA (US); Mohamed Tarek Ahmed El-Haddad, Redmond, WA (US); Junjie Hu, Bellevue, WA (US)

(21) Appl. No.: 18/134,202

(22) Filed: Apr. 13, 2023

(51) Int. Cl. G02B 27/00; F21V 8/00; G06F 3/01; G06T 7/73; H04N 23/56

(52) U.S. Cl. CPC G02B 27/0093; G02B 6/0026; G02B 6/005; G06F 3/013; G06T 7/73; H04N 23/56; G06T 2207/30201

(57) ABSTRACT

A waveguide system in a lens assembly of a head mounted device may be used to support eye tracking operations. The waveguide system includes a waveguide, an input coupler, and an output coupler. The input coupler is disposed in the waveguide, and the input coupler is configured to in-couple light into the waveguide. The output coupler is disposed in the waveguide and is configured to out-couple the light from the waveguide. The output coupler includes at least one trapezoidal portion to condition the depth of field for the waveguide system. The output coupler may have two (dual) trapezoidal portions that are similar to the shape of a bowtie or hourglass to configure the depth of field of the waveguide system along a particular direction (e.g., the y-axis). The bowtie shape of the output coupler provides uniform in-coupling of light from the input coupler along a range of angles.

### TECHNICAL FIELD

This disclosure relates generally to optics, and in particular to aperture configuration in an eye tracking system.

### BACKGROUND INFORMATION

Eye tracking technology enables head mounted displays (HMDs) to interact with users based on the users' eye movement or eye orientation. Existing eye tracking systems can be technically limited by natural obstructions. For example, eyelashes and eyelids can obstruct images taken of an eye, which may decrease the quality of eye tracking operations.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIGS. 1A, 1B, and 1C illustrate aspects of a head mounted device and a waveguide system configured to in-couple light from within the field-of-view of an eye of a user, in accordance with aspects of the disclosure.

FIGS. 2A, 2B, and 2C illustrate various views of depth of field drawbacks that may be associated with a rectangular output coupler.

FIGS. 3A, 3B, 3C, 3D, 3E, 3F, 3G, and 3H illustrate a number of views of waveguide systems implementing variations of an output coupler for depth of field configuration in an eye tracking system, in accordance with aspects of the disclosure.

FIG. 4 illustrates a flow diagram of a process for eye tracking with a head mounted device, in accordance with aspects of the disclosure.

### DETAILED DESCRIPTION

Embodiments of an output coupler for depth of field configuration in an eye tracking system are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In aspects of this disclosure, visible light may be defined as having a wavelength range of approximately 380 nm to 700 nm. Non-visible light may be defined as light having wavelengths that are outside the visible light range, such as ultraviolet light and infrared light. In aspects of this disclosure, red light may be defined as having a wavelength range of approximately 620 to 750 nm, green light may be defined as having a wavelength range of approximately 495 to 570 nm, and blue light may be defined as having a wavelength range of approximately 450 to 495 nm.

As used herein, a diffractive optical element (DOE) may include a holographic grating. A holographic grating may include a substrate with a photosensitive material onto which gratings (e.g., grating planes) are recorded (e.g., internal to the substrate). A holographic grating may also be referred to as a holographic optical element (HOE). One type of HOE is a volume Bragg grating (VBG).

Eye tracking functionality expands the services and quality of interaction that head mounted device can provide to users. Eyelashes and eyelids can block and inhibit the quality of signal (e.g., image) available from an eye when imaging is performed from a periphery of an eye. A significantly better position for imaging light reflections from an eye is from directly in front of the eye (“in-field” or “within the field-of-view”). However, placing a camera right in front of an eye could obstruct the vision of a user and could be an annoyance that reduces the quality of a user's experience with a head mounted device. Disclosed herein are techniques for a waveguide system that captures light from an eye, from directly in front of an eye, and from in-field for the eye. The waveguide system directs light from an in-field portion of a lens assembly to an image sensor that may be positioned on or in a frame of the head mounted device.

An optical system having a narrow depth of field may inhibit performance of the system by introducing aberrations and reducing image quality. Depth of field may be defined as a range of distances (e.g., from a lens or waveguide system) over which a resolution (e.g., 100 um) can be maintained. Depth of field may have an inversely proportional relationship with the aperture or apertures of the optical system. A larger aperture may be associated with a smaller/shorter depth of field for a particular resolution, and a smaller aperture may be associated with a larger/longer depth of field. A rectangular output coupler may provide a larger aperture (limited depth of field) or non-uniform light coupling. A larger depth of field provides flexibility along an optical axis of the optical system and may therefore be advantageous to the optical system. In eye tracking systems, a larger depth of field may enable better eye tracking operations when an eye is at different distances from the optical system. People have unique facial structures and various eye sizes, so a larger depth of field in an optical system of a head mounted device may enable the head mounted device to operate effectively/flexibly on a wider range of potential users.

A waveguide system may be included in a lens assembly of a head mounted device to support eye tracking operations for the head mounted device. The waveguide system may include a waveguide, an input coupler, and an output coupler for configuring depth of field. The disclosed output coupler is configured to reduce the aperture of the waveguide system for a particular direction (e.g., y-axis) to define, improve, and/or configure the depth of field for the waveguide system for the particular direction. The output coupler is configured to provide at least 5 mm of depth of field along the y-axis and at least 5 mm of depth of field along the x-axis with a resolution of 100 μm. The output coupler is configured to receive light from an input coupler having a larger footprint, and the input coupler operates as a lens to direct light onto the output coupler along an x-axis and a y-axis. Notably, volume Bragg gratings are capable of strongly redirecting light in one direction (e.g., x-axis), but light redirected in a second direction (e.g., y-axis) is weakly redirected. The disclosed output coupler is configured to maintain uniformity across the angles of light that are in-coupled from an input coupler. If controlling the depth of field by simply narrowing a rectangular coupler, then light is no longer in-coupled uniformly, in contrast to using a non-rectangular and trapezoidal shaped output coupler.

The output coupler may have at least one portion that is trapezoidal. The trapezoidal output coupler may have a longer end directed towards (e.g., positioned nearer) the input coupler and may have a shorter end directed away from (e.g., positioned farther) the input coupler. The trapezoidal output coupler may have a shorter end directed towards the input coupler and may have a longer end directed away the input coupler.

The output coupler may have two trapezoidal portions coupled together in the shape of a bowtie or hourglass. The length and width of the output coupler are shorter than the length and width of the input coupler, to facilitate placement in a frame of the head mounted device and to support coupling light to an image sensor. The dual trapezoidal shape of the output coupler may be configured to improve depth of field of the waveguide system along the particular direction to enable the waveguide system to receive light from an eye positioned at different distances/depths from the input coupler, for example. Advantageously, the dual trapezoidal shape of the output coupler may reduce aberration and improve image quality by reducing the aperture size of the waveguide system along the, for example, y-axis. Advantageously, the dual trapezoidal shape of the output coupler may provide a more uniform imaging quality map for point sources around the eyebox and reduce losing light that is reflected from the eyebox.

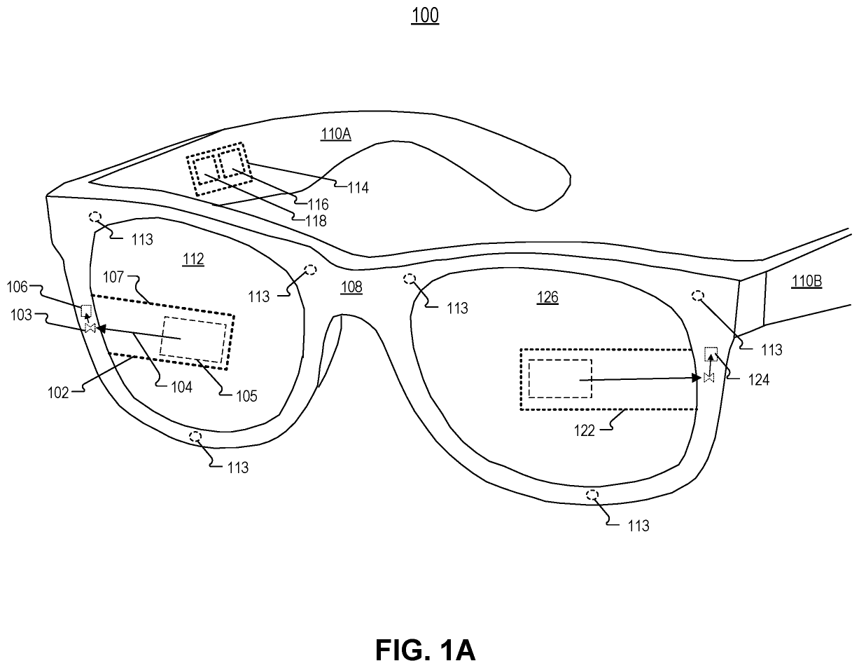

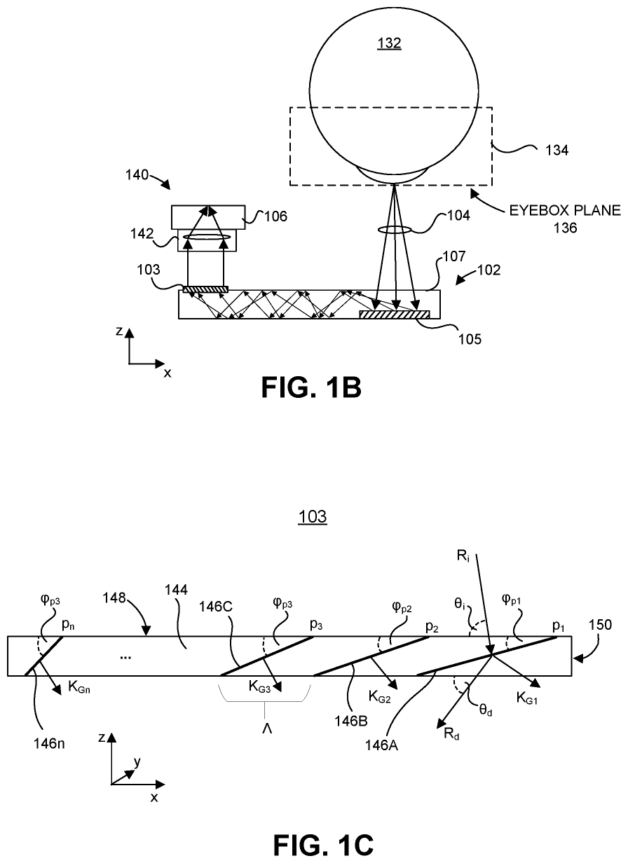

The apparatus, system, and method for the output coupler for depth of field configuration that are described in this disclosure may result in improvements to image quality in an eye tracking system. These and other embodiments are described in more detail in connection with FIGS. 1A-4.

FIGS. 1A, 1B, and 1C illustrate example diagrams of various aspects of a head mounted device 100 and a waveguide system 102 configured to in-couple light from within the field-of-view of an eye of a user, in accordance with aspects of the disclosure. Waveguide system 102 includes an output coupler 103 that is configured to receive light 104 from an input coupler 105, in accordance with aspects of the disclosure. Output coupler 103 employs a non-rectangular shaped footprint to extend the depth of field of waveguide system 102, as compared to a rectangular shaped output coupler, according to an embodiment. Output coupler 103 may have a footprint that is at least partially trapezoidal or may have a footprint that is shaped like a bowtie or hourglass to configure the depth of field in, for example, a y-axis direction of waveguide system 102, according to an embodiment. Output coupler 103 is configured to maintain uniformity across the angles of light that are in-coupled from input coupler 105, according to an embodiment. Output coupler 103 and input coupler 105 may be positioned in a waveguide 107 and may be implemented as one or more of a variety of diffractive optical elements (DOE), such as a volume grating, a volume HOE, or a volume Bragg grating (VBG), for example. A head mounted device, such as head mounted device 100, is one type of smart device. In some contexts, head mounted device 100 is also a head mounted display (HMD) that is configured to provide artificial reality. Artificial reality is a form of reality that has been adjusted in some manner before presentation to the user, which may include, e.g., virtual reality (VR), augmented reality (AR), mixed reality (MR), hybrid reality, or some combination and/or derivative thereof.

Head mounted device 100 includes waveguide system 102 and an image sensor 106 to support eye tracking functions, in accordance with aspects of the disclosure. Waveguide system 102 may include output coupler 103, input coupler 105, and waveguide 107 to direct light 104 to image sensor 106. Image sensor 106 may be coupled to a frame 108 and may be configured to receive light from waveguide system 102. Image sensor 106 may be a complementary metal-oxide-semiconductor (CMOS) image sensor. A bandpass filter may be placed in front of image sensor 106 to filter out unwanted light. Image sensor 106 may be configured to capture images of non-visible (e.g., near infrared) light. Image sensor 106 is configured to capture images of light that is reflected from an eyebox region and onto input coupler 105. Waveguide system 102 is coupled to a lens assembly 112 and may be formed in one or more layers of lens assembly 112. Waveguide system 102 is configured to receive reflections of light from the eyebox region and is configured to direct the light to image sensor 106, according to an embodiment.

Lens assembly 112 is coupled or mounted to frame 108, for example, around a periphery of lens assembly 112. Lens assembly 112 may include a prescription optical layer matched to a particular user of head mounted device 100 or may be non-prescription lens. Lens assembly 112 may include a number of optical layers, such as an illumination layer, a display layer (e.g., that includes a display), a waveguide layer (e.g., that includes waveguide system 102), and/or a prescription layer, for example. Frame 108 may be coupled to arms 110A and 110B for securing head mounted device 100 to the head of a user. The illustrated head mounted device 100 is configured to be worn on or about a head of a wearer of head mounted device 100.

Head mounted device 100 includes a number of light sources 113 that are configured to emit light into the eyebox region (e.g., onto an eye), in an embodiment. Light sources 113 may be positioned at one or more of a variety of locations on frame 108 and may be oriented to selectively illuminate the eyebox region with, for example, light that is not in the visible spectrum (e.g., near infrared light). Light sources 113 may include one or more of light emitting diodes (LEDs), photonic integrated circuit (PIC) based illuminators, micro light emitting diode (micro-LED), an edge emitting LED, a superluminescent diode (SLED), or vertical cavity surface emitting lasers (VCSELs).

Head mounted device 100 includes a controller 114 communicatively coupled to image sensor 106 and light sources 113, according to an embodiment. Controller 114 is configured to control the illumination timing of light sources 113, according to an embodiment. Controller 114 may be configured to synchronize operation of light sources 113 with image sensor 106 to enable image sensor 106 to capture reflections of light emitted by light sources 113. Controller 114 is coupled to image sensor 106 to receive images captured by image sensor 106 using waveguide system 102, according to an embodiment. Controller 114 may include processing logic 116 and one or more memories 118 to analyze image data received from image sensor 106 to: determine an orientation of one or more of a user's eyes, perform one or more eye tracking operations, and/or display or provide user interface elements in lens assembly 112, according to an embodiment. Controller 114 may be configured to provide control signals to light sources 113 or other actuators (e.g., an in-field display of the lens assembly) in head mounted device 100 based on the estimated eye orientation. Controller 114 may include a wired and/or wireless data interface for sending and receiving data, one or more graphic processors, and one or more memories 118 for storing data and computer-executable instructions. Controller 114 and/or processing logic 116 may include circuitry, logic, instructions stored in a machine-readable storage medium, ASIC circuitry, FPGA circuitry, and/or one or more processors. In one embodiment, head mounted device 100 may be configured to receive wired power. In one embodiment, head mounted device 100 is configured to be powered by one or more batteries. In one embodiment, head mounted device 100 may be configured to receive wired data including video data via a wired communication channel. In one embodiment, head mounted device 100 is configured to receive wireless data including video data via a wireless communication channel.

Head mounted device 100 may include a waveguide system 122 and an image sensor 124 positioned on or around a lens assembly 126 that is on, for example, a left side of frame 108. Waveguide system 122 may include similar features as waveguide system 102, and image sensor 124 may be configured to operate similarly to image sensor 106, according to an embodiment. Lens assembly 126 may include similar features and/or layers as lens assembly 112, and controller 114 may be configured to control light sources 113 and image sensors 106 and 124.

FIG. 1B illustrates an example side view of waveguide system 102, in accordance with aspects of the disclosure. As illustrated, light 104 may be reflected off of eye 132 that is at least partially located in eyebox region 134. Output coupler 103 and input coupler 105 may be disposed in or may be coupled to (e.g., an outside surface of) waveguide 107 within waveguide system 102. Output coupler 103 and input coupler 105 may be partially disposed in and may be partially out of waveguide 107 within waveguide system 102. Waveguide 107 may be configured to direct light 104 from input coupler 105 to output coupler 103 using total internal reflection (TIR). Output coupler 103 may be configured to direct light 104 to a camera 140. Camera 140 includes image sensor 106 and a lens 142, according to an embodiment. Lens 142 may be used to focus light 104 onto one or more portions of the pixel array of image sensor 106 to enable imaging of the portion(s) of eye 132 that reflected light 104. Eyebox region 134 may include an eyebox plane 136 that represents a portion of eyebox region 134 being in-coupled or imaged by waveguide system 102.

FIG. 1C illustrates an example side view of output coupler 103 implemented as a VBG, in accordance with aspects of the disclosure. Output coupler 103 includes a body 144 and a number of grating planes 146. Body 144 includes a volume defined by a length (x-axis), width (y-axis), and height (z-axis), according to an embodiment.

Grating planes 146 are configured to diffract incident light that satisfies various characteristics (e.g., wavelength of light, incident angle, etc.) of the design of grating planes 146, in accordance with aspects of the disclosure. Grating planes 146 may include an n number of planes and may be individually referenced as grating plane 146A, 146B, 146C, . . . 146n. Grating planes 146 include characteristics such as grating plane angles q, grating vectors K, and a grating plane period A. Each of grating planes 146 includes a corresponding one of grating plane angles q (individually, grating plane angle φp1, φp2, φp3, . . . φpn). Grating plane angles q define an angle of a grating plane with respect to a surface 148 or with respect to a surface 150, for example. Grating plane angles φ at least partially determine diffraction characteristics of grating planes 146 and may differ from one end to the other end of the folding coupler to diffract light in a particular way. Each of grating planes 146 includes a corresponding one of grating vectors K (individually, grating vector KG1, KG2, KG3, . . . . KGn). Grating vectors K may also be referred to as “grating k vectors” or simply as “k vectors”. A grating k vector is a characteristic of a grating plane that determines an angle of diffraction for a particular incident light ray. For example, light ray Ri may be directed to grating plane KG1 with an incident angle of θi and may be diffracted by grating plane KG1 to become light ray Rd with a diffraction angle of θd. A grating k vector is equal to the difference between an incident light beam vector (e.g., light ray Ri) and an exit light beam vector (e.g., light ray Rd) such that KG1=Ri−Rd). Grating plane period A is a distance between grating planes 146. Characteristics of grating planes 146 may be defined to enable output coupler 103 to out-couple light from waveguide 107. Additionally, grating plane angles q may be different on one end than on another end of output coupler 103 to enable customized diffraction based on where incident light is received on output coupler 103, according to an embodiment. Input coupler 105 may also have grating planes that enable the in-coupling operations disclosed herein.

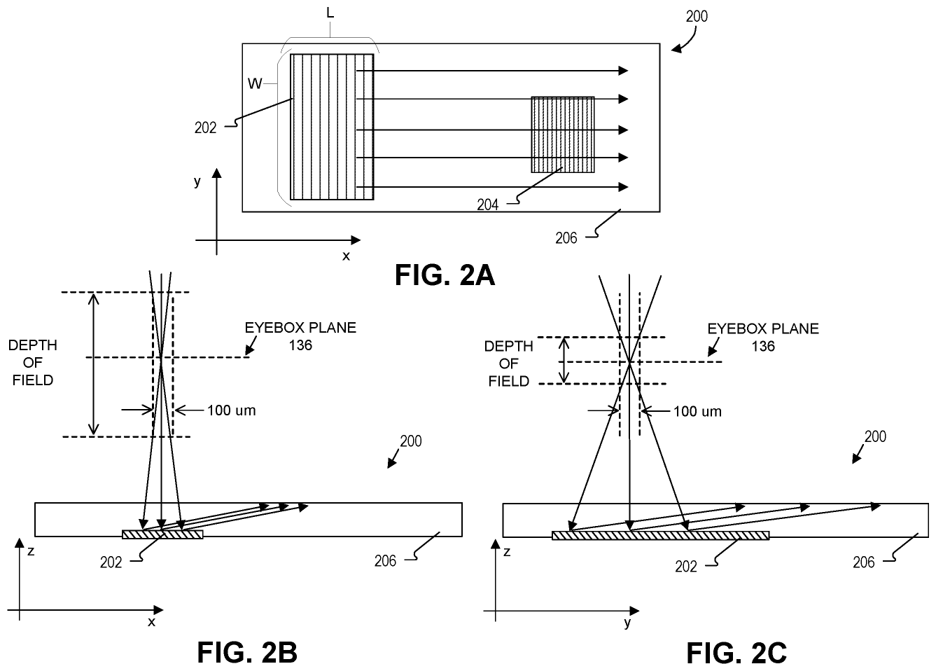

FIGS. 2A, 2B, and 2C illustrate various views of a waveguide system 200 having depth of field drawbacks or deficiencies that may be associated with a rectangular output coupler. Waveguide system 200 includes an in-coupling optical element 202 and an out-coupling optical element 204 disposed in a waveguide 206. The in-coupling optical element 202 includes a length L along the x-axis and a width W along the y-axis. The length L is shorter (e.g., half as long) as the width W. The inventors discovered that a rectangular shape for out-coupling optical element 204 may result in a large aperture and a small depth of field along the y-axis direction, when the length L is significantly shorter than the width W. FIG. 2A illustrates a top-view of waveguide system 200 along the x-axis and y-axis. FIG. 2B illustrates a side-view of in-coupling optical element 202 along the x-axis and z-axis within waveguide system 200. FIG. 2B illustrates that the depth of field of approximately 5 mm for an aperture size or resolution of 100 um along the x-axis. However, FIG. 2C illustrates that along the y-axis, in-coupling optical element 202 receives light over a much larger cone angle, which limits the depth of field to approximately 300 um for an aperture size or resolution of 100 um along the y-axis. The mismatch in depth of fields along the x-axis and y-axis may produce aberrations and diminished image quality, which illustrates how a rectangular (e.g., nearly square) out-coupling optical element 204 may be improved upon. Furthermore, the depths of field along the x-axis and y-axis may operate together to produce a combined depth of field that is smaller than either individual depth of field.

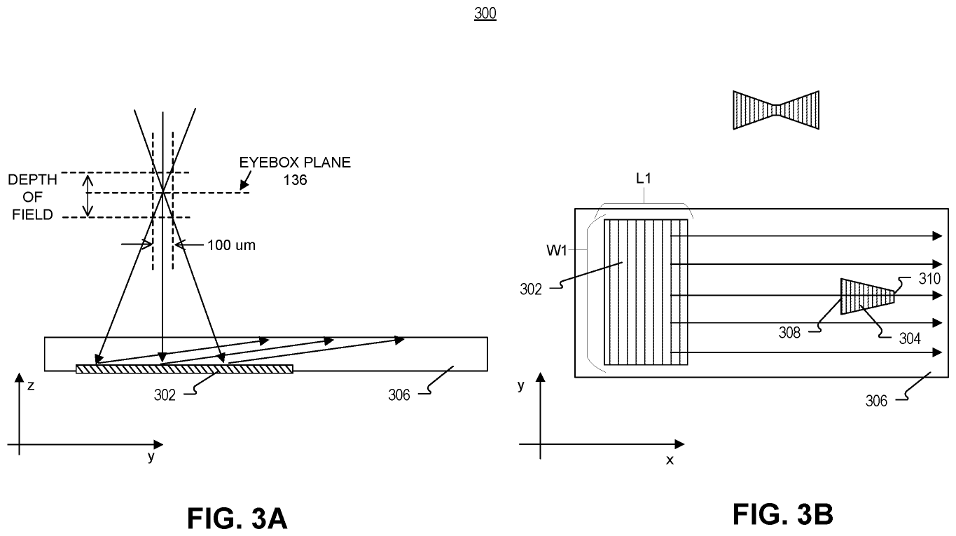

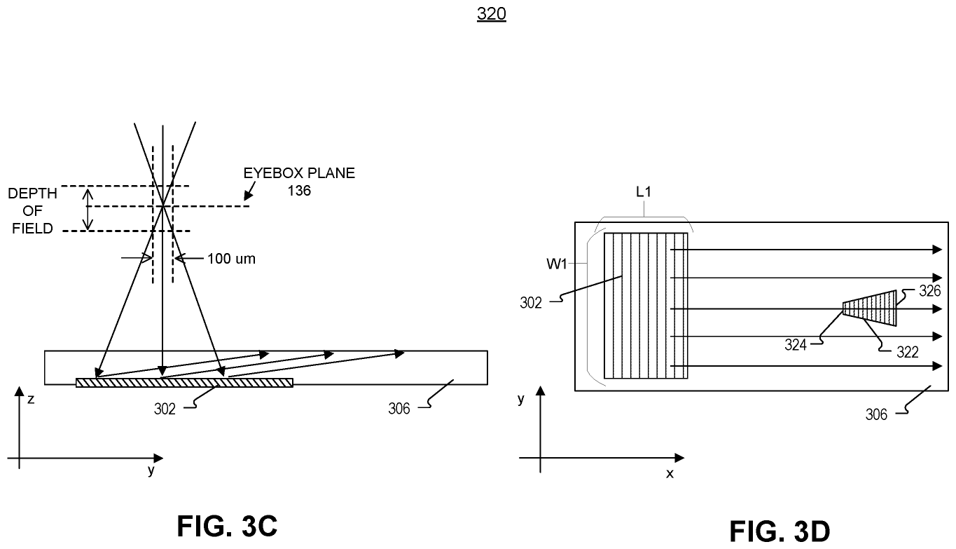

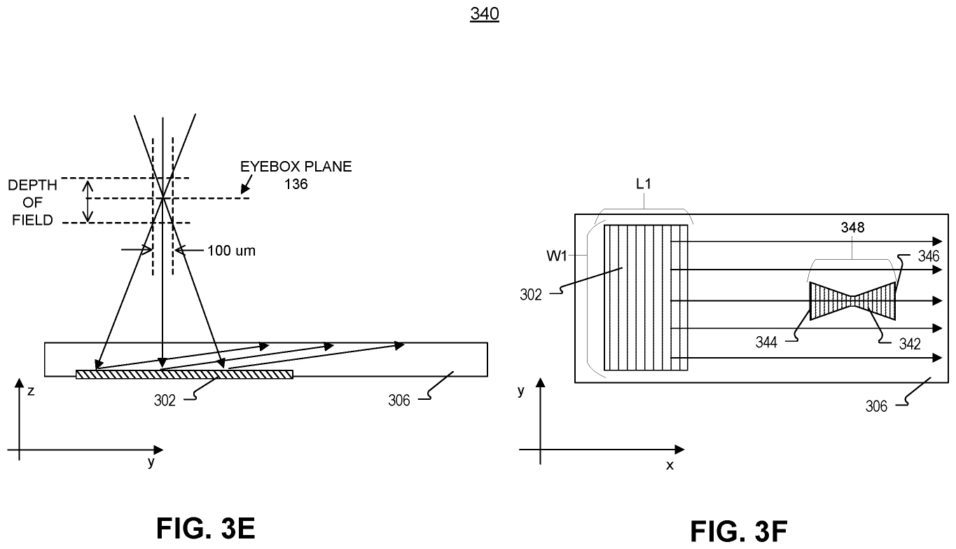

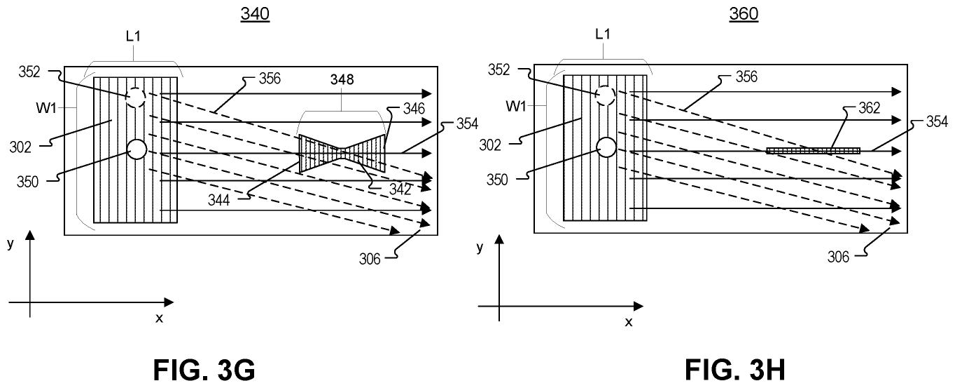

FIGS. 3A, 3B, 3C, 3D, 3E, and 3F illustrate a number of views of waveguide systems implementing variations of an output coupler for depth of field configuration in an eye tracking system, in accordance with aspects of the disclosure. FIG. 3A illustrates a side-view of waveguide system 300, and FIG. 3B illustrates a top-view of waveguide system 300, according to an embodiment. Waveguide system 300 includes an input coupler 302 and an output coupler 304 disposed in a waveguide 306. Input coupler 302 includes a length L1 along the x-axis and a width W1 along the y-axis. The length L1 is shorter (e.g., half as long) than the width W1. Length L1 is approximately 7.5 mm, and width W1 is approximately 15 mm. Output coupler 304 is configured to have a smaller footprint area than input coupler 302, so that output coupler 304 can fit inside of a frame of a head mounted device, according to an embodiment. Output coupler 304 is trapezoidal shaped and is configured to narrow the aperture of waveguide system 300, which results in a greater depth of field value than a rectangular (or nearly square) output coupler. By reducing the footprint (as compared to a rectangular coupler) of output coupler 304 along the y-axis, the width of the conical light along the y-axis of input coupler 302 is reduced by filtering or omitting the out-coupling of some of the light. For example, the dimensions of output coupler 304 may be configured to transmit light that is incident upon portion 312 of input coupler 302 and may be configured to not transmit (e.g., filter or omit) light that is incident upon portions 314 of input coupler 302, according to an embodiment. Output coupler 304 includes a longer end 308 and a shorter end 310. Longer end 308 may be proximal to (i.e., nearer/closer) input coupler 302, and shorter end 310 may be distal to (i.e., farther from) input coupler 302. The shape of output coupler 304 is configured to maintain uniformity across the angles of light that are in-coupled from input coupler 302, according to an embodiment. Longer end 308 may be a fraction of length L1 or width W1 (e.g., 20% or less of width W1). FIG. 3A illustrates that the effective depth of field (DOF) 311, based on the operation of output coupler 304, of waveguide system 300 may be at least approximately 3 mm for an aperture size or resolution of 100 um along the x-axis. From center-to-center, output coupler 304 may be positioned 21 mm from input coupler 302 and may be adjusted along the x-axis with a tolerance of 8-10 mm, for example.

FIGS. 3C and 3D illustrate a waveguide system 320 having an output coupler for depth of field configuration, in accordance with aspects of the disclosure. Waveguide system 320 may include input coupler 302 and an output coupler 322 disposed in waveguide 306, according to an embodiment. Output coupler 322 may include a shorter end 324 and a longer end 326. Shorter end 324 may be proximal to input coupler 302 and longer end 326 may be distal to input coupler 302, according to an embodiment. The shape of output coupler 322 is configured to maintain uniformity across the angles of light that are in-coupled from input coupler 302, according to an embodiment.

FIGS. 3E and 3F illustrate a waveguide system 340 having an output coupler for depth of field configuration, in accordance with aspects of the disclosure. Waveguide system 340 may include input coupler 302 and an output coupler 342 disposed in a waveguide 306, according to an embodiment. Output coupler 342 may have a footprint having a bowtie or hourglass shape to reduce the aperture of waveguide system 340 along a particular direction (e.g., the y-axis of waveguide system 340). Output coupler 342 may include a short end 344 positioned proximal to input coupler 302 and may include a short end 346 positioned distal to input coupler 302. Output coupler 342 may include a longitudinal length 348 along the x-axis of waveguide 306. Longitudinal length 348 may be a fraction of length L1 or width W1. The shape of output coupler 342 is configured to maintain uniformity across the angles of light that are in-coupled from input coupler 302, according to an embodiment.

FIGS. 3G and 3H illustrate waveguide systems operating on light from different point sources, in accordance with aspects of the disclosure. FIG. 3G illustrates waveguide system 340 receiving light beam bundles from a point source 350 and from a point source 352. Point source 350 may represent light from a center of the eyebox region, and point source 352 may represent light from around a periphery of the eyebox region. Light beam bundle 354 represents columnated light from point source 350 that traverses waveguide 306 along the x-axis. Light beam bundle 356 represents columnated light from point source 352 that traverses waveguide 306 along both the x-axis and y-axis. FIG. 3G illustrates light beam bundle 354 and light beam bundle 356 incident upon output coupler 342 at different angles and illustrates how output coupler 342 may uniformly in-couple light beam bundles across different angles. With the hourglass shape, both light beam bundles see a large enough interaction area where the light can be coupled out. FIG. 3H illustrates a waveguide system 360 with a slit-shaped output coupler 362. The slit-shaped output coupler 362 provides a much smaller interaction area for the off-axis source light beam bundles (e.g., light beam bundle 356). If the light beam bundle has a large angle inside waveguide 306, the light beam bundle will have a higher chance of missing the output coupler all-together. This can cause loss of eyebox images in imaging applications and may degrade system performance.

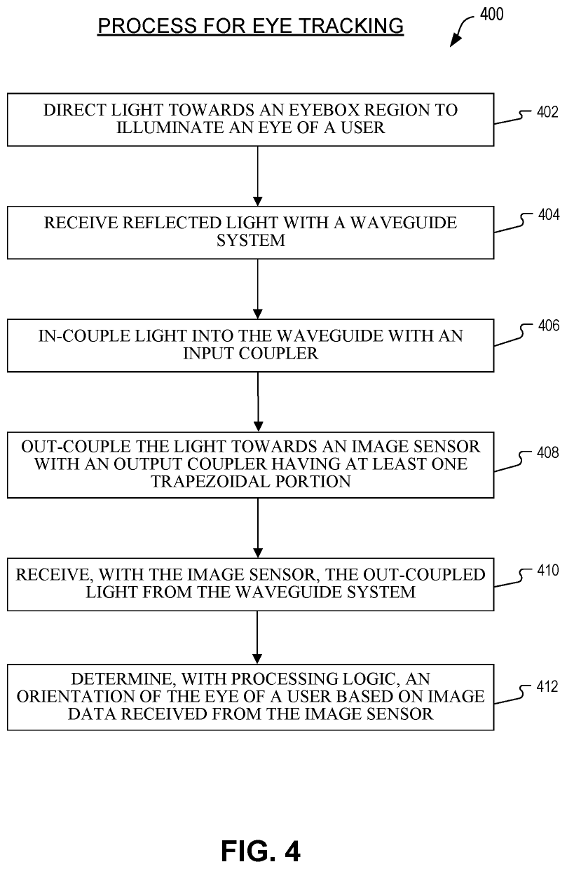

FIG. 4 illustrates a flow diagram of a process for eye tracking with a head mounted device, in accordance with aspects of the disclosure. Process 400 may be at least partially incorporated into or performed by a head mounted device (e.g., an HMD), according to an embodiment. The order in which some or all of the process blocks appear in process 400 should not be deemed limiting. Rather, one of ordinary skill in the art having the benefit of the present disclosure will understand that some of the process blocks may be executed in a variety of orders not illustrated, or even in parallel.

At process block 402, process 400 includes directing light towards an eyebox region to illuminate an eye of a user, according to an embodiment. Directing light may include selectively turning infrared light sources on/off to illuminate an eyebox region. The light sources may be mounted to a frame of a head mounted device. Process block 402 proceeds to process block 404, according to an embodiment.

At process block 404, process 400 includes receiving reflected light with a waveguide system, according to an embodiment. The waveguide system may be coupled to a lens assembly that is coupled to or carried by the frame of the head mounted device. The waveguide system may include an input coupler and an output coupler. Process block 404 proceeds to process block 406, according to an embodiment.

At process block 406, process 400 includes in-coupling light into the waveguide system with an input coupler, according to an embodiment. The input coupler is positioned, for example, directly in front of the eyebox region to enable in-field eye tracking. Process block 406 proceeds to process block 408, according to an embodiment.

At process block 408, process 400 includes out-coupling the light towards an image sensor with an output coupler having at least one trapezoidal portion, according to an embodiment. The output coupler may include two trapezoidal portions coupled together in the shape of a bowtie or hourglass. The image sensor and output coupler may be positioned inside of the frame (e.g., the waveguide system extends into the frame). Process block 408 proceeds to process block 410, according to an embodiment.

At process block 410, process 400 includes receiving, with the image sensor, the out-coupled light from the waveguide system, according to an embodiment. Process block 410 proceeds to process block 412, according to an embodiment.

At process block 412, process 400 includes determining, with processing logic, an orientation of the eye of a user based on image data generated by the image sensor, according to an embodiment. Process 400 may also include providing control signals to the light sources and/or other actuators (e.g., a display) based on the estimated or determined orientation of the eye, according to an embodiment.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g., 116) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” (e.g., 118) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

A network may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A waveguide system for a lens assembly of a head mounted device comprising:
a waveguide;
an input coupler disposed in the waveguide, wherein the input coupler is configured to in-couple light into the waveguide; and
an output coupler disposed in the waveguide and configured to out-couple the light from the waveguide, wherein a footprint of the output coupler includes at least one trapezoidal portion.

2. The waveguide system of claim 1, wherein the at least one trapezoidal portion is configured to receive light uniformly from the input coupler over a plurality of angles.

3. The waveguide system of claim 1, wherein the at least one trapezoidal portion is configured to reduce an aperture size of the waveguide system along a particular direction.

4. The waveguide system of claim 3, wherein the particular direction is along a y-axis of the waveguide system, wherein the input coupler and the output coupler are separated by a distance along an x-axis of the waveguide system.

5. The waveguide system of claim 1, wherein the at least one trapezoidal portion includes a longer end and a shorter end, wherein the longer end is proximal to the input coupler and the shorter end is distal to the input coupler.

6. The waveguide system of claim 1, wherein the at least one trapezoidal portion includes a longer end and a shorter end, wherein the shorter end is proximal to the input coupler and the longer end is distal to the input coupler.

7. The waveguide system of claim 1, wherein the at least one trapezoidal portion includes two trapezoidal portions coupled together in an hourglass shape.

8. The waveguide system of claim 7, wherein a first short end of the hourglass shape is proximal to the input coupler and a second short end of the hourglass shape is distal to the input coupler.

9. The waveguide system of claim 1, wherein the input coupler and the output coupler are volume Bragg gratings.

10. The waveguide system of claim 1, wherein the at least one trapezoidal portion is configured to provide at least 5 mm of depth of field with a resolution of 100 um.

11. A head mounted device comprising:
a frame;
an image sensor coupled to the frame;
a lens assembly coupled to the frame and configured to transmit scene light to an eyebox region; and
a waveguide system coupled to the lens assembly and to the frame, wherein the waveguide system includes:
a waveguide;
an input coupler configured to in-couple light from an eyebox region into the waveguide; and
an output coupler configured to out-couple light from the waveguide towards the image sensor, wherein the output coupler includes at least one trapezoidal portion.

12. The head mounted device of claim 11, wherein the at least one trapezoidal portion is configured to receive light uniformly from the input coupler over a plurality of angles.

13. The head mounted device of claim 11, wherein the at least one trapezoidal portion is configured to reduce an aperture size of the waveguide system along a particular direction.

14. The head mounted device of claim 11, wherein the at least one trapezoidal portion includes two trapezoidal portions coupled together in an hourglass shape.

15. The head mounted device of claim 11, wherein the input coupler and the output coupler are configured to operate on non-visible light.

16. The head mounted device of claim 11, wherein the input coupler and output coupler are volume Bragg gratings.

17. A method of eye tracking with a head mounted device comprising:
receiving light from an eyebox region of a head mounted device;
coupling the light into a waveguide; and
coupling the light out of the waveguide with an output coupler, wherein the output coupler includes at least one trapezoidal portion.

18. The method of claim 17, wherein the at least one trapezoidal portion includes two trapezoidal portions coupled together into an hourglass shape.

19. The method of claim 17 further comprising:
receiving, with an image sensor, the light from the output coupler;
generating, with the image sensor, image data that is representative of reflections of the light from the eyebox region; and
determining an orientation of an eye of a user based on the image data.

20. The method of claim 19 further comprising:
emitting light with light sources that are oriented towards the eyebox region; and
generating control signals to control the light sources based on the orientation of the eye.
